(19) United States
(12) Patent Application Publication
(10) Pub. No.: US 2007/0176108 A1
(43) Pub. Date: Aug. 2, 2007

(54) Semiconductor-based image sensor

(75) Inventors: Olaf Such, Aachen (DE); Josef Lauter, Geilenkirchen (DE); Michael Gnade, Duisburg (DE); Dirk Weiler, Herne (DE); Armin Kemna, Duisburg (DE); Gereon Vogtmeier, Aachen (DE); Roger Steadman, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/597,017

(22) PCT Filed: Jan. 7, 2005
(86) PCT No.: PCT/IB05/50092

§ 371 Date: Jul. 6, 2006

(30) Foreign Application Priority Data
Jan. 12, 2004 (EP) 04100073.8

(51) Int. Cl. G01T 1/24; H01L 27/146

(52) U.S. Cl. 250/370.09; 250/371

(57) ABSTRACT

A detector arrangement and/or a semiconductor-based image sensor with a plurality of detector elements or image pixels is described, which each have an integrated SD-(Sigma Delta) Modulator (20 to 29) or an integrated SD-A/D-(Sigma Delta Analog/Digital) converter (20 to 30), as well as particularly such a detector arrangement and/or such an image sensor on the basis of a CMOS-semiconductor. Particularly on the basis of the differential version and/or the multi-phase structure of the SD modulator and the SD-A/D converter, a detector arrangement and/or an image sensor with specially high noise robustness, a high dynamic range and a lesser noise can be produced, so that this is particularly suitable for usage in Computer Tomography (CT) apparatus.

The invention relates to a detector arrangement and a semiconductor-based image sensor respectively, with a plurality of detector elements or image pixels, which each has an integrated SD (Sigma Delta) modulator or an integrated SD-A/D (Sigma Delta Analog/Digital) converter, as well as particularly such a detector arrangement or such an image sensor respectively, on the basis of a CMOS semiconductor structure. The invention also relates to an X-ray detector and an X-ray apparatus, particularly for Computer Tomography (CT) with such an arrangement of detectors.

A CMOS image sensor with a plurality of pixels each formed by at least a photo detector (or photo transistor) and an A/D converter assigned to each pixel in the form of a sigma delta (SD) modulator is known from U.S. Pat. No. 5,461,425. The A/D converters are each arranged in intermediate areas of the photo transistors in the pixel arrangement and therewith in the image sensor. This image sensor should be produced cost-effectively and be specially efficient, so that good quality images can be generated. But this image sensor is not suitable or only limitedly so, for applications in X-ray detectors, since for these applications, special demands of high dynamic range and low noise are made.

An object of this invention therefore comprises creating a detector arrangement and an image sensor with a plurality of detector elements or image pixels, which each show an integrated SD (Sigma Delta) modulator or an integrated SD-A/D (Sigma Delta Analog/Digital) converter, which shows a sufficiently high dynamic range particularly for the application in X-ray technology.

Furthermore a detector arrangement and an image sensor of the type described above should be provided, which show(s) a specially high signal-to-noise ratio, as is specially required for the application in X-ray technology.

Eventually a detector arrangement or an image sensor respectively, of the kind described above, should also be provided, which is specially suitable for application in Computer Tomography.

The object is achieved with a detector arrangement with a plurality of detector elements or image pixels, which each have an integrated SD modulator, wherein the SD modulator has a differential design and/or a plurality of stages.

Special advantages of this solution comprise, that the detector arrangement or an image sensor respectively, showing this shows a high interference robustness, a high dynamic range and low noise.

The contents of the dependent claims are advantageous further embodiments of the invention.

Further details, features and advantages of the invention are apparent from the following description of preferred embodiments with reference to the drawing. It shows in:

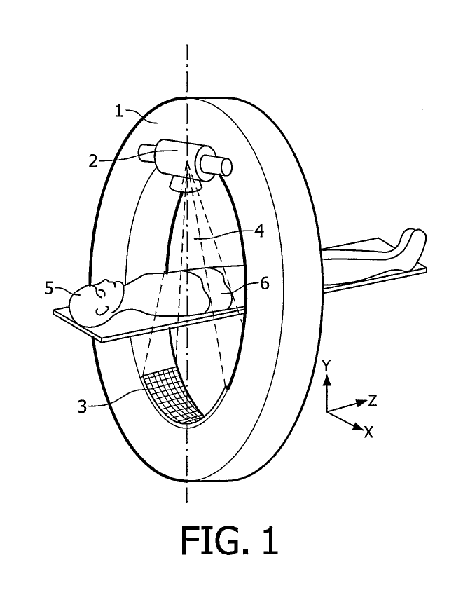

FIG. 1 a diagrammatic representation of essential components of a Computer Tomography apparatus.

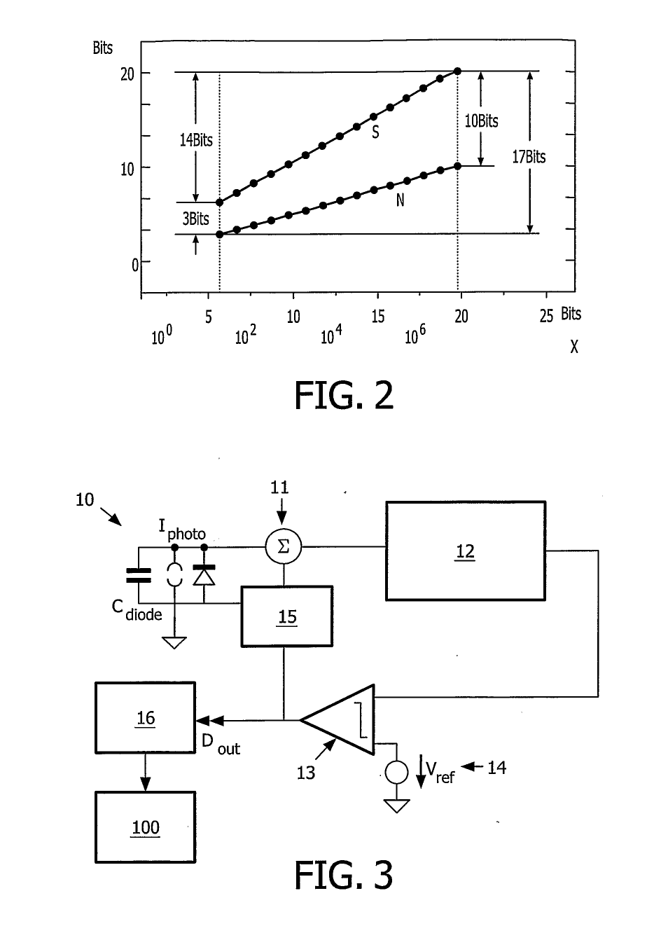

FIG. 2 a graphical representation of the dynamic range of a detector signal depending upon the number of detected photons.

FIG. 3 a basic circuit diagram according to the invention for processing the signals of a detector element.

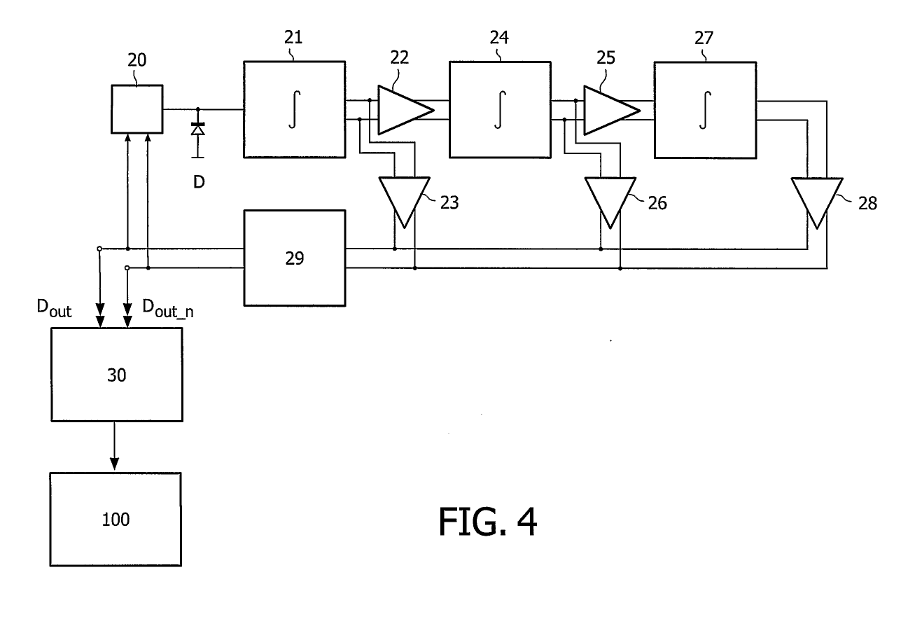

FIG. 4 a block circuit diagram for processing the signals of a detector element according to the invention; and

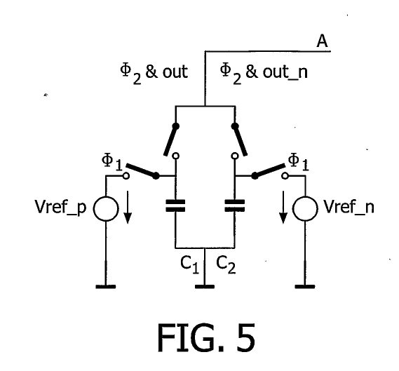

FIG. 5 a component of the circuit shown in FIG. 4 in detail.

FIG. 1 diagrammatically shows essential components of a Computer Tomography (CT) apparatus. The apparatus comprises a gantry 1, on whose circumference an X-ray source 2 as well as an opposite detector arrangement 3 is secured. The X-ray source 2 generates a fan or pyramid like X-ray bundle 4, which is directed towards the detector arrangement 3. Through the inside of the gantry 1 (z direction) and thereby through the X-ray bundle 4 an object of examination or a patient 5 respectively, is passed. As the gantry 1 rotates at the same time, the examination area 6 of the patient 5 lying in the plane of the gantry 1 is penetrated with the X-rays from various directions, so that in known manner a cross-section of the examination area 6 can be calculated from the image data recorded by the detector arrangement 3.

The detector arrangement 3 is generally a part of an image sensor, with which the X-rays are detected and processed, in order to calculate and generate an image of the examination area. The detector arrangement 3 comprises a plurality of detector elements, which each correspond to an image pixel of the calculated image and are arranged in the form of a number of rows and columns, wherein the rows span the extent direction of the gantry 1 and the columns span perpendicularly thereto.

For clarifying the problems forming the basis of the invention FIG. 2 is referred. The usual range of fluctuation of the amplitudes of the detector signals i.e. the number of X-ray photons detected by a detector element, generally ranges between approx. 64 photons for the weakest signal and about one million photons for the strongest signal. This corresponds to a factor of approx. 16000. For the representation of a digital signal representing this number of photons up to 14 bits are thus needed.

Such an (useful) signal S is logarithmically represented in FIG. 2, wherein on the horizontal axis the number of X-ray photons and the corresponding number of bits (input signal) and on the vertical axis the number of bits of the output signal dependent on it are indicated.

The noise signal N (shot noise) results approx from the square root of the useful signal S and is likewise logarithmically represented in FIG. 2. The dissolution of the useful signal S is thus dependent on its amplitude. As results from FIG. 2, the signal-to-noise ratio for the highest detector signal amplitude comprises approx. ten bits and for the lowest detector signal amplitude about three bits. However, in order to be able to boost on the one hand the smallest noise signal N (corresponding to eight photons) and on the other hand the largest useful signal S (approx. one million photons), a total dynamic range of approx. 17 bits is needed.

In order to be able to arrange a correspondingly efficient read amplifier in direct proximity of the detector elements, preferably CMOS or other highly integrated semi conductor structures are used. For the processing and digitization of the analog output signals of each detector element with such a high dynamic range preferably a SD-A/D (Sigma Delta Analog-to-Digital) converters are used.

FIG. 3 shows the principle realization of such a SD-A/D converter, which comprises an oversampling-modulator (SD modulator) and a decimation filter, wherein for each detector element of the detector arrangement such an SD-A/D converter is provided.

The detector element is represented in the mode of the equivalent circuit diagram of a photo diode 10 having a capacitance C_{diode}, a current source Iₚₕₒₜₒ as well as the diode path D. Generally there is a scintillation layer on the photo diode, with which layer the incident X-rays are converted into visible light, which is then detected by the photo diode.

The photo stream generated by the photo diode is proportional to the generated light intensity and thus also proportional to the X-rays to be detected.

The photo stream is supplied to an analog summing apparatus, whose output is connected to an integrator realized in the form of a loop filter 12. The loop filter 12 comprises preferably a filter bank, which may be for e.g. of second, third and fourth-order filter bank.

The output of the loop filter 12 is connected to a first input of a clocked comparator 13, at whose second input there is a reference voltage 14. The digital output signal of the comparator 13 is led to a current feedback Digital/Analog converter 15, whose output is connected to the analog summing apparatus 11.

The output of the comparator 13 simultaneously represents the SD modulator output at which there is a digital 1 Bit data stream Dₒᵤₜ. This data stream is led to a decimation filter 16, at the same clock rate at which also the comparator 13 is clocked. With the decimation filter 16 the digital 1-Bit data stream is then converted to a lower sampling rate with a higher dynamic range, for e.g. to a 17 Bit data signal and led to an image processing and generation apparatus 100.

The SD-AD converter can then each time be directly integrated in the relevant detector element pixel), or the SD-A/D converter(s) is (are) at least on the same chip and/or substrate as the detector arrangement. There is then the possibility of integrating either the SD modulator and the decimator filter together in the detector element or arranging only the decimation filter on the chip and/or substrate. Furthermore, modulators of other class and other topology can also naturally be used.

FIG. 4 shows a block diagram of a higher-order SD A/D converter in differential design.

The photo stream generated by the photo diode D is applied to a three-stage loop filter, which comprises a series connection of a first integrator 21 with connected first and second amplifiers 22, 23 for an a₁- and/or b₁-filter coefficient respectively, a second integrator 24 with connected third and fourth amplifiers 25, 26 for an a₂- and/or b₂-filter coefficient respectively, as well as a third integrator 27 with connected fifth amplifier 28 for a b₃-filter coefficient.

The outputs of the second, fourth and fifth amplifiers 23, 26, 28 are connected to the input of a likewise differentially designed comparator 29.

Both the differential levels of the filtered signal are compared to each other in the comparator 29. The output signal of the comparator 29 again actuates a current feedback Digital/Analog converter 20, which preferably comprises an SC (switched capacitor) current source and whose output is connected to the photo diode D.

The output of the comparator 29 also represents again the SD modulator output, at which digital 1 Bit data streams Dₒᵤₜ and Dₒᵤₜ_{_{—}}ₙ are present as output signals. These data streams are led to a decimation filter 30. With the decimation filter 30 the digital 1 Bit data streams are then converted into a lower sample rate with a higher dynamic range for example into a 17 Bit data signal and applied to an image processing and generation apparatus 100.

Especially in the case where a large number of detector elements are implemented on a common (and relatively large) chip area with associated SD-A/D converters, the differential design has decisive advantages. In this case is namely averted, that too large transient currents have to be pressed on the chip area.

Furthermore, the coupling to the substrate is reduced. This is likewise of great importance due to the matrix arrangement of the detector elements (particularly in the above-mentioned CT apparatus).

FIG. 5 shows a basic circuit diagram of the SC current source, which is preferably used in the current feedback Digital/Analog converter 20. This current source basically comprises a positive and negative reference voltage source V_{ref}_{_{—}}ₚ, V_{ref}_{_{—}}ₙ as well as a first and a second condenser C₁, C₂. The first and second condenser C₁, C₂ respectively, can be switched via a switch actuated by a clock edge Φ₁, Φ₁, either parallel to the relevant reference voltage source or to an output terminal A, in order to implement a charge pump in this way.

Such a SC current source is hence particularly advantageous, because it shows only a very low temperature dependency. With the usage for compensation of the photo current, it offers a current input for the SD modulator (“Current Mode operation”) and enables the implementation of an SD modulator with very low noise, which is of importance with regard to the necessary high dynamic range and the detection of very small photo currents. Besides, the SC current sources have a very low space requirement, so that it presents itself in a detector element particularly with the integration of an SD modulator and an SD-A/D converter.

A further advantage of the SD A/D converter shown in FIG. 4 comprises the fact the input signal supplied by the photo diode D is time continously integrated, as the integrator does not need to be reset and thus there are no dead times. In this way the digitized detector data can be read out continuously.

Altogether the integration of a higher-order SD-A/D converter shown in FIG. 4 and in differential version in a detector element or pixel respectively, thus offers numerous advantages with reference to a higher dynamic range of more than 60 dB, a lesser noise as well as a higher linearity. Furthermore, owing to the noise robustness achieved with the differential version numerous SD-A/D converters of an image sensor can be switched in parallel, so that no multiplexers are necessary.

To increase the stability of the SD-A/D converter preferably an Auto-Zero-comparator is used as comparator 29.

Furthermore a cascaded arrangement of a plurality of SD-A/D converters in a detector element or pixels respectively, is possible. The above-mentioned characteristics and advantages can therein be furthermore improved.

A particularly preferred realisation is the combination of at least one SD-A/D converter with an integrated CMOS-Photodiode in each detector element and pixels respectively of a detector arrangement and an image sensor in CMOS technology with a digital output for an image processing and generating apparatus 100. Such a detector arrangement can preferably be used for image detection and as X-ray detector in a Computer Tomography apparatus shown in FIG. 1.

The invention relates to a detector arrangement and a semiconductor-based image sensor respectively, with a plurality of detector elements or image pixels, which each has an integrated SD (Sigma Delta) modulator or an integrated SD-A/D (Sigma Delta Analog/Digital) converter, as well as particularly such a detector arrangement or such an image sensor respectively, on the basis of a CMOS semiconductor structure. The invention also relates to an X-ray detector and an X-ray apparatus, particularly for Computer Tomography (CT) with such an arrangement of detectors.

A CMOS image sensor with a plurality of pixels each formed by at least a photo detector (or photo transistor) and an A/D converter assigned to each pixel in the form of a sigma delta (SD) modulator is known from U.S. Pat. No. 5,461,425. The A/D converters are each arranged in intermediate areas of the photo transistors in the pixel arrangement and therewith in the image sensor. This image sensor should be produced cost-effectively and be specially efficient, so that good quality images can be generated. But this image sensor is not suitable or only limitedly so, for applications in X-ray detectors, since for these applications, special demands of high dynamic range and low noise are made.

An object of this invention therefore comprises creating a detector arrangement and an image sensor with a plurality of detector elements or image pixels, which each show an integrated SD (Sigma Delta) modulator or an integrated SD-A/D (Sigma Delta Analog/Digital) converter, which shows a sufficiently high dynamic range particularly for the application in X-ray technology.

Furthermore a detector arrangement and an image sensor of the type described above should be provided, which show(s) a specially high signal-to-noise ratio, as is specially required for the application in X-ray technology.

Eventually a detector arrangement or an image sensor respectively, of the kind described above, should also be provided, which is specially suitable for application in Computer Tomography.

The object is achieved with a detector arrangement with a plurality of detector elements or image pixels, which each have an integrated SD modulator, wherein the SD modulator has a differential design and/or a plurality of stages.

Special advantages of this solution comprise, that the detector arrangement or an image sensor respectively, showing this shows a high interference robustness, a high dynamic range and low noise.

The contents of the dependent claims are advantageous further embodiments of the invention.

Further details, features and advantages of the invention are apparent from the following description of preferred embodiments with reference to the drawing. It shows in:

FIG. 1 a diagrammatic representation of essential components of a Computer Tomography apparatus.

FIG. 2 a graphical representation of the dynamic range of a detector signal depending upon the number of detected photons.

FIG. 3 a basic circuit diagram according to the invention for processing the signals of a detector element.

FIG. 4 a block circuit diagram for processing the signals of a detector element according to the invention; and

FIG. 5 a component of the circuit shown in FIG. 4 in detail.

FIG. 1 diagrammatically shows essential components of a Computer Tomography (CT) apparatus. The apparatus comprises a gantry 1, on whose circumference an X-ray source 2 as well as an opposite detector arrangement 3 is secured. The X-ray source 2 generates a fan or pyramid like X-ray bundle 4, which is directed towards the detector arrangement 3. Through the inside of the gantry 1 (z direction) and thereby through the X-ray bundle 4 an object of examination or a patient 5 respectively, is passed. As the gantry 1 rotates at the same time, the examination area 6 of the patient 5 lying in the plane of the gantry 1 is penetrated with the X-rays from various directions, so that in known manner a cross-section of the examination area 6 can be calculated from the image data recorded by the detector arrangement 3.

The detector arrangement 3 is generally a part of an image sensor, with which the X-rays are detected and processed, in order to calculate and generate an image of the examination area. The detector arrangement 3 comprises a plurality of detector elements, which each correspond to an image pixel of the calculated image and are arranged in the form of a number of rows and columns, wherein the rows span the extent direction of the gantry 1 and the columns span perpendicularly thereto.

For clarifying the problems forming the basis of the invention FIG. 2 is referred. The usual range of fluctuation of the amplitudes of the detector signals i.e. the number of X-ray photons detected by a detector element, generally ranges between approx. 64 photons for the weakest signal and about one million photons for the strongest signal. This corresponds to a factor of approx. 16000. For the representation of a digital signal representing this number of photons up to 14 bits are thus needed.

Such an (useful) signal S is logarithmically represented in FIG. 2, wherein on the horizontal axis the number of X-ray photons and the corresponding number of bits (input signal) and on the vertical axis the number of bits of the output signal dependent on it are indicated.

The noise signal N (shot noise) results approx from the square root of the useful signal S and is likewise logarithmically represented in FIG. 2. The dissolution of the useful signal S is thus dependent on its amplitude. As results from FIG. 2, the signal-to-noise ratio for the highest detector signal amplitude comprises approx. ten bits and for the lowest detector signal amplitude about three bits. However, in order to be able to boost on the one hand the smallest noise signal N (corresponding to eight photons) and on the other hand the largest useful signal S (approx. one million photons), a total dynamic range of approx. 17 bits is needed.

In order to be able to arrange a correspondingly efficient read amplifier in direct proximity of the detector elements, preferably CMOS or other highly integrated semi conductor structures are used. For the processing and digitization of the analog output signals of each detector element with such a high dynamic range preferably a SD-A/D (Sigma Delta Analog-to-Digital) converters are used.

FIG. 3 shows the principle realization of such a SD-A/D converter, which comprises an oversampling-modulator (SD modulator) and a decimation filter, wherein for each detector element of the detector arrangement such an SD-A/D converter is provided.

The detector element is represented in the mode of the equivalent circuit diagram of a photo diode 10 having a capacitance C_{diode}, a current source Iₚₕₒₜₒ as well as the diode path D. Generally there is a scintillation layer on the photo diode, with which layer the incident X-rays are converted into visible light, which is then detected by the photo diode.

The photo stream generated by the photo diode is proportional to the generated light intensity and thus also proportional to the X-rays to be detected.

The photo stream is supplied to an analog summing apparatus, whose output is connected to an integrator realized in the form of a loop filter 12. The loop filter 12 comprises preferably a filter bank, which may be for e.g. of second, third and fourth-order filter bank.

The output of the loop filter 12 is connected to a first input of a clocked comparator 13, at whose second input there is a reference voltage 14. The digital output signal of the comparator 13 is led to a current feedback Digital/Analog converter 15, whose output is connected to the analog summing apparatus 11.

The output of the comparator 13 simultaneously represents the SD modulator output at which there is a digital 1 Bit data stream Dₒᵤₜ. This data stream is led to a decimation filter 16, at the same clock rate at which also the comparator 13 is clocked. With the decimation filter 16 the digital 1-Bit data stream is then converted to a lower sampling rate with a higher dynamic range, for e.g. to a 17 Bit data signal and led to an image processing and generation apparatus 100.

The SD-AD converter can then each time be directly integrated in the relevant detector element (pixel), or the SD-A/D converter(s) is (are) at least on the same chip and/or substrate as the detector arrangement. There is then the possibility of integrating either the SD modulator and the decimator filter together in the detector element or arranging only the decimation filter on the chip and/or substrate. Furthermore, modulators of other class and other topology can also naturally be used.

FIG. 4 shows a block diagram of a higher-order SD A/D converter in differential design.

The photo stream generated by the photo diode D is applied to a three-stage loop filter, which comprises a series connection of a first integrator 21 with connected first and second amplifiers 22, 23 for an a₁- and/or b₁-filter coefficient respectively, a second integrator 24 with connected third and fourth amplifiers 25, 26 for an a₂- and/or b₂-filter coefficient respectively, as well as a third integrator 27 with connected fifth amplifier 28 for a b₃-filter coefficient.

The outputs of the second, fourth and fifth amplifiers 23, 26, 28 are connected to the input of a likewise differentially designed comparator 29.

Both the differential levels of the filtered signal are compared to each other in the comparator 29. The output signal of the comparator 29 again actuates a current feedback Digital/Analog converter 20, which preferably comprises an SC (switched capacitor) current source and whose output is connected to the photo diode D.

The output of the comparator 29 also represents again the SD modulator output, at which digital 1 Bit data streams Dₒᵤₜ and Dₒᵤₜ_{_{—}}ₙ are present as output signals. These data streams are led to a decimation filter 30. With the decimation filter 30 the digital 1 Bit data streams are then converted into a lower sample rate with a higher dynamic range for example into a 17 Bit data signal and applied to an image processing and generation apparatus 100.

Especially in the case where a large number of detector elements are implemented on a common (and relatively large) chip area with associated SD-A/D converters, the differential design has decisive advantages. In this case is namely averted, that too large transient currents have to be pressed on the chip area.

Furthermore, the coupling to the substrate is reduced. This is likewise of great importance due to the matrix arrangement of the detector elements (particularly in the above-mentioned CT apparatus).

FIG. 5 shows a basic circuit diagram of the SC current source, which is preferably used in the current feedback Digital/Analog converter 20. This current source basically comprises a positive and negative reference voltage source V_{ref}_{_{—}}ₚ, V_{ref}_{_{—}}ₙ as well as a first and a second condenser C₁, C₂. The first and second condenser C₁, C₂ respectively, can be switched via a switch actuated by a clock edge Φ₁, Φ₁, either parallel to the relevant reference voltage source or to an output terminal A, in order to implement a charge pump in this way.

Such a SC current source is hence particularly advantageous, because it shows only a very low temperature dependency. With the usage for compensation of the photo current, it offers a current input for the SD modulator (“Current Mode operation”) and enables the implementation of an SD modulator with very low noise, which is of importance with regard to the necessary high dynamic range and the detection of very small photo currents. Besides, the SC current sources have a very low space requirement, so that it presents itself in a detector element particularly with the integration of an SD modulator and an SD-A/D converter.

A further advantage of the SD A/D converter shown in FIG. 4 comprises the fact the input signal supplied by the photo diode D is time continously integrated, as the integrator does not need to be reset and thus there are no dead times. In this way the digitized detector data can be read out continuously.

Altogether the integration of a higher-order SD-A/D converter shown in FIG. 4 and in differential version in a detector element or pixel respectively, thus offers numerous advantages with reference to a higher dynamic range of more than 60 dB, a lesser noise as well as a higher linearity. Furthermore, owing to the noise robustness achieved with the differential version numerous SD-A/D converters of an image sensor can be switched in parallel, so that no multiplexers are necessary.

To increase the stability of the SD-A/D converter preferably an Auto-Zero-comparator is used as comparator 29.

Furthermore a cascaded arrangement of a plurality of SD-A/D converters in a detector element or pixels respectively, is possible. The above-mentioned characteristics and advantages can therein be furthermore improved.

A particularly preferred realisation is the combination of at least one SD-A/D converter with an integrated CMOS-Photodiode in each detector element and pixels respectively of a detector arrangement and an image sensor in CMOS technology with a digital output for an image processing and generating apparatus 100. Such a detector arrangement can preferably be used for image detection and as X-ray detector in a Computer Tomography apparatus shown in FIG. 1.

1. A detector arrangement with a plurality of detector elements or image pixels, which each have an integrated SD modulator, wherein the SD modulator has a differential design and/or a plurality of stages.

2. A detector arrangement as claimed in claim 1, wherein the SD modulator is extended with a decimation filter to a SD-A/D converter.

3. A detector arrangement as claimed in claim 1, wherein the detector elements or image pixels as well as the SD modulators are realized on a CMOS-semiconductor structure.

4. A detector arrangement as claimed in claim 1, wherein the SD modulator has a current feedback on the signal of the detector element with an SC current source.

5. A detector arrangement as claimed in claim 1, wherein a cascaded arrangement of SD modulators in at least one detector element or image pixel is provided.

6. A detector arrangement as claimed in claim 1, wherein the SD modulator has an Auto-Zero-Comparator.

7. A semiconductor-based image sensor with a detector arrangement as claimed in claim 1.

8. An X-ray detector with a detector arrangement as claimed in claim 1.

9. An X-ray apparatus, particularly for computer tomography, with a detector arrangement as claimed in claim 1.
